(19) United States
(12) Patent Application Publication
(10) Pub. No.: US 2021/0381624 A1
(43) Pub. Date: Dec. 9, 2021

(54) Multi-Use Mounting Bracket Assembly

(71) Applicants: Noel F. Mascarenhas, Houston, TX (US); Manjunath Mavinakere, Houston, TX (US)

(72) Inventors: Noel F. Mascarenhas, Houston, TX (US); Manjunath Mavinakere, Houston, TX (US)

(21) Appl. No.: 17/340,846

(22) Filed: Jun. 7, 2021

Related U.S. Application Data
(60) Provisional application No. 63/035,813, filed on Jun. 7, 2020.

(51) Int. Cl. F16L 3/227; F16L 3/137

(52) U.S. Cl. CPC F16L 3/227; F16L 3/137

(57) ABSTRACT

A bracket assembly designed to securely grip and mount posts of various diameters, sizes, and cross-sectional shapes, to structures in different orientations and applications. Typical applications are mounting an umbrella, flag-post, birdfeeder, lights, hanging garden pot, torch and similar applications.

### CROSS-REFERENCE TO RELATED APPLICATIONS

This application claims priority under 35 U.S.C. § 119(e) from co-pending U.S. Provisional Patent Application No. 63/035,813, by Mascarenhas, et al., “Multi-Use Mounting Bracket Assembly” filed 7 Jun. 2020, which, by this statement, is incorporated herein by reference for all purposes.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The invention relates generally to positioning and attaching objects to structures, particularly to outside structures to secure against movements in during storms and/or high winds. Specifically, the invention is directed to securely mounting items of different cross-sectional shapes and sizes, to fences, other structures, or for similar applications.

In prior art for such a device, clamps and screws are a typical method of securing objects with non-compatible shapes or differing sizes. Unique brackets exist for specific applications but can only accommodate up to a certain diameter, thickness, or shape. Or may not exist for a specific situation.

Other methods fail to secure the objects in relation to each other, allowing slippage when placed under forces in particular directions. In other situations, elements may prevent the objects from being positioned in the desired orientation due to interference, or a lack of alignment for screws or other fasteners to secure them together.

### BRIEF DESCRIPTION OF THE DRAWINGS

FIGS. 1 & 2 show a front view and a top view of a multi-use mounting bracket in accordance with an exemplary embodiment of the invention.

FIG. 3 illustrates a perspective view of a multi-use mounting bracket in accordance with an exemplary embodiment of the invention.

FIG. 4 shows one embodiment of a multi-use mounting bracket assembly in accordance with an exemplary embodiment of the invention.

FIG. 5 shows another embodiment of a multi-use mounting bracket assembly in accordance with an exemplary embodiment of the invention.

FIG. 6 illustrates an exemplary embodiment for mounting an umbrella to a fence picket in accordance with an exemplary embodiment of the invention.

FIG. 7 illustrates another view of the exemplary deployment in the previous figure.

### DETAILED DESCRIPTION OF THE PREFERRED EMBODIMENTS

In the preferred embodiment, the bracket assembly is comprised of two distinct parts; a bracket and band clamps. The upper and lower flanges of the bracket have their ends cut into a V-shape, with specially shaped teeth profiles created from stair stepping the depth of the cut to form gripping sides of the V-shaped relief notch for round post, accommodate different widths for squared edges, or other cross-sectional shapes without rotation or slippage.

The teeth permit the bracket to securely mate with, and in some cases bite into and grip posts of any cross-sectional profile such as round, square, rectangular, oval, or irregular shapes as well. In the preferred embodiment, the bracket is symmetrical and hence reversible to use. However, one skilled in the arts would appreciate that this is not a requirement of functioning in a patentable manner.

The bracket assembly is designed for mounting post in various orientations. The term post is used to encompass generally cylindrical objects of varying diameters and various cross-sectional shapes, including but not limited to: poles, pipes, tubes, rods, shafts, etc. The “post” may be a primary part of the mounted object or may be a specific component tor mounting that is securely attached to and capable of supporting the rest of the object.

For ease of understanding, and without intending to limit the invention, the remainder of this description shall focus on a preferred example. Illustrated and discussed further herein is the mounting of a large outdoor table sized umbrella having a center post, which is being mounted to a square metal fence picket of a fence having a top rail wider than the picket.

The height of the bracket is determined by the length of the center plate joining the flanges. The specific height is not a limiting factor and may vary in different embodiments. The physical dimensions should be designed for specific embodiments designed to withstand the physical loads and twisting (bending) expected to occur during working conditions and in consideration of the manufacturing materials.

Various heights, widths, and depths can be manufactured for different applications. Material thickness can be selected based on material strength and/or expected forces depending on intended deployments. For example, twisting forces on an umbrella or flag-post would be different from that experienced by a bird feeder or torch. Heavy plastic may be sufficient to hold a bird feeder. A short bracket of thin aluminum may be preferred for a tiki torch. But, a taller flange of thick aluminum or steel may be required to secure an umbrella post, particularly in a windy environment.

In the preferred example, the wider top rail prevents aligning the umbrella post with a fence picket without angling the umbrella. Additionally, the umbrella can be significantly affected by even slight winds causing an upward force or is constantly affected by gravity causing a constant downward force. Either, or the alternating application of both tends to stress any mounting efforts.

The I shaped bracket described here is configured to grip the surface of the secured post or mounted object to prevent slipping under force. The slots cut into the bracket accommodate the band clamps that are used to clamp the bracket to the mounting post and may be used to secure to the structure, such as the described fence. But there are also keyhole slots for screw or bolt mounting as well.

By securing the post with band clamps through the slots which are located between the teeth on the upper and lower flanges, a stronger grip is ensured on the post due to two reasons. One is that the teeth on the flanges, as well as the tooth-cuts around the circumference of the band clamp, indent into the material of the post and thus “bite” into it, creating enough friction that will prevent slip. The second is that the band clamps, being centered between the upper and lower flanges, in effect cause a bending moment in the post between the two flanges, thus causing a slight deformation in the post that will also prevent the post from moving or slipping.

The teeth in both the upper and lower flanges, as well as the slots cut around the band clamp circumference, secure the post in a torsional direction as well, and prevent it from rotating about its longitudinal axis. This keeps the post in a predetermined orientation, that in which it was first mounted.

Banding clamps are commercially available in a wide range of sizes in order to accommodate many applications making the bracket application universal in nature. Zip ties also offer a banding option that can apply forces and are available in reusable or one-time use configurations. Band clamping is also available in a format that utilizes disposable banding and a crimp clip securing the band ends by using a crimp tool. The banding material is available in metals or plastics and used for items as small as household water pipes to as large as truckloads of logs being secured to trailers before transport.

Two or more bracket assemblies may be used in tandem or series, in order to provide more strength and grip to a mounted object or to secure it in multiple dimensions. Band clamps may be substituted or supplemented by other binding materials such as wire, rope, bungee, strap, tape, or similar materials.

The bracket design is capable of securing and accommodating a large range of sizes and shapes of posts and mounting objects. The end user will be assured of proper fit of this bracket due to the critical design features which allows it to securely grip and mount the post. This is accomplished with the unique design combination of a mounting bracket, along with special geometry gripper teeth and band clamps. In this manner, the bracket is capable of mounting virtually any size or cross-sectional shape of post, whether round, oval, square, rectangular, or almost any other shape for a typical application. Various diameter band clamps are used as required in order to accommodate different sizes of posts and mounting objects such as fences, posts, gates or other objects.

In another embodiment of the current invention, the bracket may be used in another orientation and for other mounting applications as deemed suitable by the user, by utilizing the additional holes and/or slots provided.

In another embodiment of this invention, the bracket may be shorter or longer in height, in order to allow the user to mount two or more brackets, separated sufficiently to provide greater stability or based on available mounting space and load requirements of the application.

In another embodiment of this invention, the teeth in the upper and lower flanges may not be present or may be of other shapes and geometry to suit the application, such as flat, concave, or convex or custom shape. The teeth may only be located on one end of a flange with the other end having a different profiles. In one embodiment, teeth on one end of a flange may grip a wooden post, and the distal end may be padded to prevent scratching, or be rubberized to prevent slippage against a material where using teeth would result in less contact area due to inability to bite in.

In another embodiment of the current invention, the post to be mounted may need to be inclined at an angle to the vertical or horizontal. This embodiment may have flanges of different lengths and are joined by a non-rectangular center plate.

In the preferred embodiment, the center plate is joined to the flanges with a fillet to strengthen the joint. One skilled in the art would appreciate that other embodiments may glue the flanges to the center plate, other embodiments may use extruded stock for the entire bracket body, welded plates, glued plates, etc. and the innovation is not limited to the manufacturing material and/or method.

### Detailed Description of the Drawings

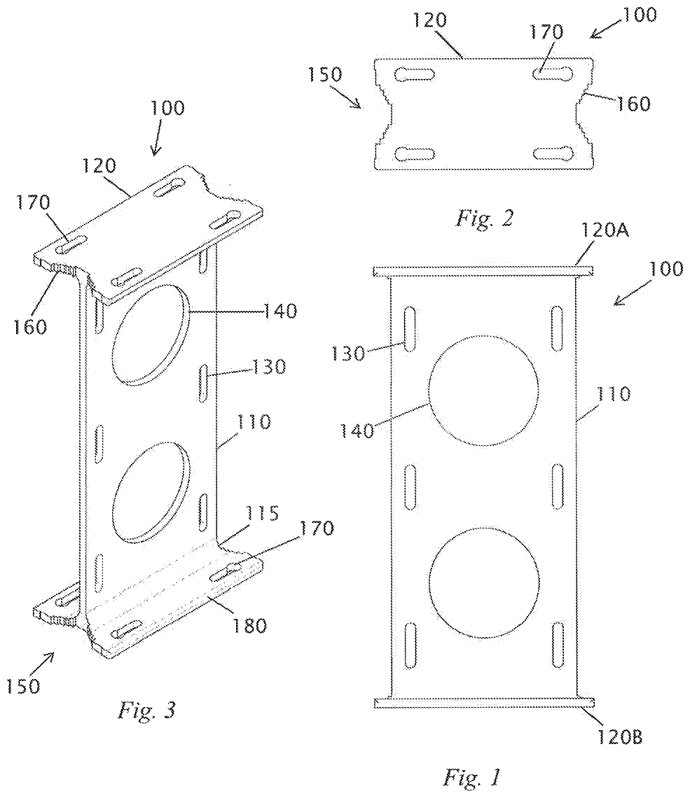

FIGS. 1 & 2 show a front view and a top view of a multi-use mounting bracket in accordance with an exemplary embodiment of the invention. The I-shaped multi-use bracket (100) has a center plate (110) joined to flanges (120) at the top (120A) and the bottom (120B).

Optional circular openings (140) may reduce weight and allow additional strapping or connection opportunities. Elongated slots (130) or banding slots are aligned along each end of the center plate (110).

Each end of a flange (120) has a V-shaped relief or notch (150). The sides of the notches may have stair stepped sides forming teeth (160). Keyhole slots (170) are aligned along each side of the flanges (120) and may be oriented opposite each other to prevent unintentional disengagement from screws securing them to a structural element.

FIG. 3 illustrates a perspective view of a multi-use mounting bracket in accordance with an exemplary embodiment of the invention. In this orientation the joint filet (115) between the center plate (110) and the flanges (120) is visible. The stair stepped sides of the V-shaped notches produce teeth (160) to bite into a post, but edges of the flanges (120) may be rounded (180) for safety.

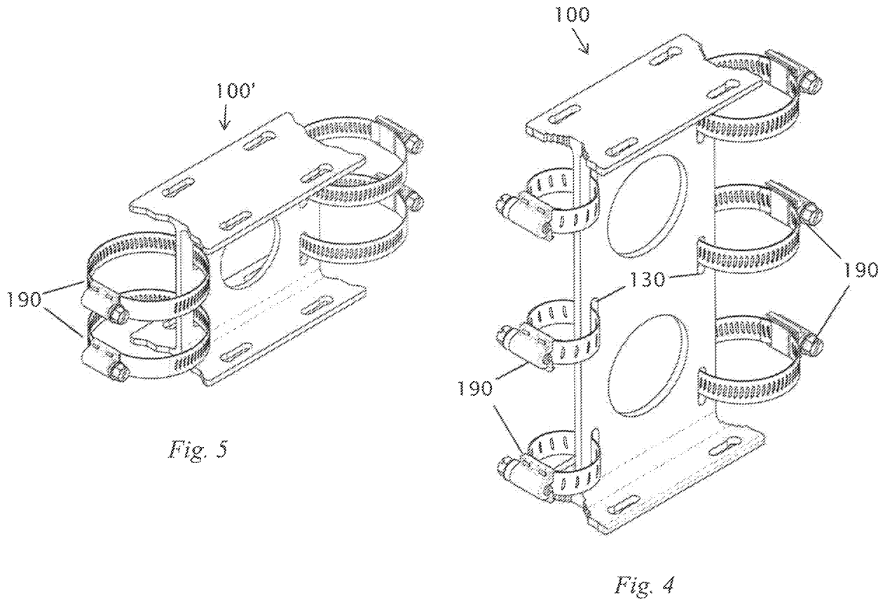

FIG. 4 shows one embodiment of a mounting bracket assembly in accordance with an exemplary embodiment of the invention. The preferred embodiment (100) has adjustable banding (190), or band clamps inserted into the elongated slots, or band slots (130) on each end of the center plate (110, not indicated).

FIG. 5 shows another embodiment of a mounting bracket assembly in accordance with an exemplary embodiment of the invention. This alternative embodiment (110′) has less adjustable banding (190) and a shorter height allowing Fir multiple mounting brackets (110′) to be spread apart protecting against twisting.

FIG. 6 illustrates an exemplary embodiment for mounting an umbrella to a fence picket in accordance with an exemplary embodiment of the invention. A mounting bracket (100) secures an umbrella (300) by its central shaft or post (310). To a structure, here a fence (200) with a top rail (210) significantly wider than a picket (220). The obstruction of the top rail (210) prevents the alignment of the post (310) directly adjacent to the picket (220) requiring the spacing provided by the bracket (100) before mounting with banding (190).

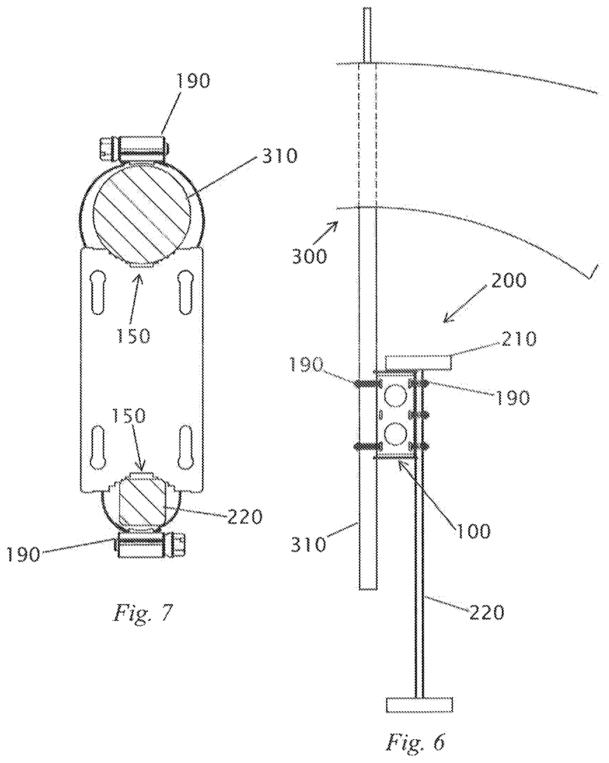

FIG. 7 illustrates another view of the exemplary deployment in the previous figure. This cross section, taken below the top rail (210 of FIG. 6) and oriented downward, shows the versatility of the mounting bracket's flanges (120). The round post (310) of the umbrella (300, not indicted) is pushed into the V-shaped relief (150) by the band clamp (190) so the teeth (160 not indicated) bite into it preventing rotation.

On the distal end, the picket (220) of the fence (200, not indicated), is pushed into the V-shaped relief (150) by the band clamp (190) engaging the teeth (160 not indicated), not by biting, but still engaging the corners of the square shaped picket (220) preventing a rotation.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A mounting bracket comprised of:
an I shaped body comprising:
a center plate extending between and connected at distal ends along center lines of end plates, flanges; wherein:
the flanges are parallel to each other;
the flanges are perpendicular to the body; and
V-shaped reliefs centered in the end plate edges at distal ends of the center lines of each flange, wherein the V-shaped reliefs are stair stepped forming teeth along the relief sides.

2. A mounting bracket, as described in claim 1 wherein the center plate further comprises one or more elongated slots extending between the distal flanges and aligned with the center plate edge.

3. A mounting bracket, as described in claim 2 wherein the elongated slots are mated along both edges of the center plate.

4. A mounting bracket, as described in claim 1 wherein the center plate further comprises one or more circular openings along a centerline extending from flange to flange.

5. A mounting bracket, as described in claim 1 wherein a flange further comprises one or more keyhole slots aligned with an edge parallel to the center plate.

6. A mounting bracket, as described in claim 5 wherein the keyhole slots are mated along both edges of the flange.

7. A mounting bracket, as described in claim 6 wherein two keyhole slots on a single edge are oppositely oriented.

8. A mounting assembly comprised of:
an I shaped bracket comprising:
a center plate extending between and connected at distal ends along center lines of end plates, flanges; wherein:
the flanges are parallel to each other;
the flanges are perpendicular to the body; and
V-shaped reliefs centered in the end plate edges at distal ends of the center lines of each flange, wherein the V-shaped reliefs are stair stepped thrilling teeth along the relief sides;
pairs of elongated slots extending between the distal flanges and aligned with the center plate edge; and
a banding strap passing through each elongated shot and adjustably joinable around the adjacent center plate edge.

9. A mounting assembly, as described in claim 8 wherein the banding strap is a banding pipe clamp.

10. A mounting assembly, as described in claim 8 wherein the banding strap is a zip tie.

11. A mounting assembly, as described in claim 8 wherein the banding strap is a plastic or metal band and crimp clip.

12. A method of mounting a post to a structure comprising:
aligning the post's center axis with and placing it adjacent to an I shaped bracket;
the I shaped bracket comprising:
a center plate extending between and connected at distal ends along center lines of end plates, flanges; wherein:
the flanges are parallel to each other;
the flanges are perpendicular to the body; and
V-shaped reliefs centered in the end plate edges at distal ends of the center lines of each flange, wherein the V-shaped reliefs are stair stepped forming teeth along the relief sides;
pairs of elongated slots extending between the distal flanges and aligned with the center plate edge;
passing a banding strap passing through each elongated shot on the edge adjacent to the post and joining the banding strap;
tightening the strap until the teeth in the V-shaped reliefs engage the post or the post is secured in the V-shaped notches of each distal flange;
aligning the bracket with the structure;
securing the bracket to the structure.

13. The method of mounting a post described in claim 12 wherein securing the bracket to the structure comprises:
passing a banding strap passing through each elongated slot on the edge adjacent to the structure;
joining the banding strap around an element of the structure; and
tightening the strap until:
the teeth in the V-shaped reliefs engage the element,
the element is secured in the V-shaped notches of each distal flange, or
the element is secured against the distal flange.

14. The method of mounting a post described in claim 12 wherein a flange further comprises one or more keyhole slots aligned with an edge parallel to the center plate.

15. The method of mounting a post described in claim 14 wherein securing the bracket to the structure comprises:
aligning a flange of the bracket with an element of the structure;
passing screws through the keyhole slots of the flange and into the element of the structure.
